(19) United States
(12) Patent Application Publication
(10) Pub. No.: US 2013/0191314 A1
(43) Pub. Date: Jul. 25, 2013

(54) METHOD AND SYSTEM FOR EXTRACTING ROUTE CHOICE PREFERENCE OF A USER

(71) Applicant: NEC (China) Co., Ltd., Beijing (CN)

(72) Inventors: Man Li, Beijing (CN); Weisong Hu, Beijing (CN); Xiaowei Liu, Beijing (CN)

(73) Assignee: NEC (China) Co., Ltd., Beijing (CN)

(21) Appl. No.: 13/693,683

(22) Filed: Dec. 4, 2012

(30) Foreign Application Priority Data
Jan. 21, 2012 (CN) CN201210022070.8

(51) Int. Cl. G06N 5/04

(52) U.S. Cl. CPC G06N 5/04
USPC 706/46

(57) ABSTRACT

A system for extracting route choice preference of a user is provided. The system includes: a key route analysis unit configured to analyze history routes of all users to obtain key routes and their costs; and a user preference extraction unit configured to obtain feature routes of a certain user and their costs based upon the key routes and their costs as well as history routes of the certain user, and to extract route choice preference of the certain user based upon the feature routes of the certain user and their costs. Also provided is a method for extracting route choice preference of a user. The present embodiments enable automatic extraction of route choice preference of a user from history data, without requiring the user to preset his/her own preference.

### FIELD OF INVENTION

The present invention relates to the field of navigation, and more particularly, to a method and system for extracting route choice preference of a user.

### DESCRIPTION OF PRIOR ART

When making a plan for travel route, a user often needs to make a trade-off among costs (such as distance, time, comfort, security and energy-saving, etc.) of each of the routes, to choose the most suitable travel route for himself/herself. In real life, a user often needs to take account of several costs simultaneously and assign different priorities (i.e., weights) for each of the costs.

In the prior art, there already exists personalized route planning methods based on user preference. The results obtained by some of the methods are routes on which the user is concerned, the user's driving speed, etc., while others require the user to predefine concerned route costs. That is, the user is initially required to prescribe his/her concerned route costs and their respective importance degrees (typically classified into four levels: very important, important, moderate, and not important), and the next route is then predicted based upon every route choice the user has made. However, in practical application, it is very difficult for a user to accurately describe such route choice preference having multiple costs, each of which has a corresponding weight. In addition, artificially classifying the importance degrees of costs into a number of fixed levels results in a less accurate route choice preference of the user. Further, the route choice preference of the user may vary with time and geographical location.

Therefore, there is needed a technical solution enabling automatic extraction of route choice preference of a user, which does not require the user to predefine concerned route costs and can make the calculation result of user preference more accurate.

### SUMMARY OF THE INVENTION

According to an aspect of the present invention, there is provided a system for extracting route choice preference of a user, the system comprising: a key route analysis unit configured to analyze history routes of all users to obtain key routes and their costs; and a user preference extraction unit configured to obtain feature routes of a certain user and their costs based upon the key routes and their costs as well as history routes of the certain user, and to extract route choice preference of the certain user based upon the feature routes of the certain user and their costs.

Preferably, the key route analysis unit comprises: a key route extraction subunit configured to select pairs of key nodes by calculating a number of history routes of all users between any pair of nodes, and to extract the key routes based upon the selected pairs of key nodes; and a key route cost calculation subunit configured to group the key routes and to calculate cost values of the key routes in the same group for each cost.

Preferably, the user preference extraction unit comprises: a feature route extraction subunit configured to extract the feature routes of the certain user from the key routes based upon the history routes of the certain user; and a user preference calculation subunit configured to calculate weights for the route choice preference of the certain user based upon the costs of the feature routes of the certain user, and to calculate the route choice preference of the user based upon the weights.

Preferably, the key route extraction subunit is configured to select two nodes which have two or more routes connected therebetween as a pair of key nodes, and to select routes represented by a pair of key nodes and two or more of which having a frequency of occurrence that is larger than a first threshold as key routes.

Preferably, the key route cost calculation subunit is configured to put key routes having the same original node and destination node into a group, to calculate cost values of the key routes in the same group for each cost, and to compare the calculated cost values to assign the costs to the key routes.

Preferably, the key route cost calculation subunit is configured to assign a cost to a key route having an optimal value for the cost if the cost has a numerical value, and to assign a cost to each of the key routes if the cost has a non-numerical value.

Preferably, the feature route extraction subunit is configured to extract, from the history routes of the certain user, a path which is identical to a key route and has a frequency of occurrence that is larger than a second threshold as a feature route of the certain user.

Preferably, the key route analysis unit further comprises a first route classification subunit configured to classify the history routes of all users in accordance with a certain criterion, and to provide the classified history routes to the key route extraction subunit. The user preference extraction unit further comprises a second route classification subunit configured to classify the history routes of the certain user in accordance with the certain criterion, and to provide the classified history routes to the feature route extraction subunit.

Preferably, the certain criterion comprises any of time periods in a day, date type, and weather condition.

Preferably, the user preference extraction unit further comprises: a third route classification subunit configured to classify the history routes of the certain user in accordance with geographical regions, and to provide the classified history routes to the feature route extraction subunit.

Preferably, the third route classification subunit is configured to divide a map into a plurality of regions, and to classify the plurality of regions as active regions and non-active regions in accordance with a number of the history routes of the certain user and a number of total travel times for the history routes of the certain user.

According to an aspect of the present invention, there is provided a method for extracting route choice preference of a user, the method comprising: analyzing history routes of all users to obtain key routes and their costs; and obtaining feature routes of a certain user and their costs based upon the key routes and their costs as well as history routes of the certain user, and extracting route choice preference of the certain user based upon the feature routes of the certain user and their costs.

Preferably, the step of analyzing comprises: selecting pairs of key nodes by calculating a number of history routes of all users between any pair of nodes, and extracting the key routes based upon the selected pairs of key nodes; and grouping the key routes and calculating cost values of the key routes in the same group for each cost.

Preferably, the step of obtaining and extracting comprises: extracting the feature routes of the certain user from the key routes based upon the history routes of the certain user; and calculating weights for the route choice preference of the certain user based upon the costs of the feature routes of the certain user, and the route choice preference of the certain user based upon the weights.

Preferably, the steps of selecting and extracting comprise: selecting two nodes which have two or more routes connected therebetween as a pair of key nodes, and routes represented by a pair of key nodes and two or more of which having a frequency of occurrence that is larger than a first threshold as key routes.

Preferably, the steps of grouping and calculating comprise: putting key routes having the same original node and destination node into a group, calculating cost values of the key routes in the same group for each cost, and comparing the calculated cost values to assign the costs to the key routes.

Preferably, the step of comparing comprises: assigning a cost to a key route having an optimal value for the cost if the cost has a numerical value, and a cost to each of the key routes if the cost has a non-numerical value.

Preferably, the step of extracting comprises: extracting, from the history routes of the certain user, a path which is identical to a key route and has a frequency of occurrence that is larger than a second threshold as a feature route of the certain user.

Preferably, the method further comprises: classifying the history routes of all users in accordance with a certain criterion before the step of extracting the key routes; and classifying the history routes of the certain user in accordance with the certain criterion before the step of extracting the feature routes.

Preferably, the certain criterion comprises any of time periods in a day, date type, and weather condition.

Preferably, the method further comprises: classifying the history routes of the certain user in accordance with geographical regions before the step of extracting the feature routes.

Preferably, the step of classifying comprises: dividing a map into a plurality of regions, and classifying the plurality of regions as active regions and non-active regions in accordance with a number of the history routes of the certain user and a number of total travel times for the history routes of the certain user.

The systems and methods according to the present invention enable automatic extraction of route choice preference of a user from history data, without requiring the user to preset his/her own preference. The present invention also enables adjustment of the route preference choice of the user in accordance with different criteria, so that the user preference can be calculated more accurately. Moreover, the present invention enables extraction of corresponding route preferences based upon the user's familiarity with different regions, which can thus provide personalized route choice.

### BRIEF DESCRIPTION OF THE DRAWINGS

The above and other features of the present invention will be more apparent from the following detailed description taken in conjunction with the accompanying drawings, in which:

FIG. 1 is a block diagram illustrating a system for extracting route choice preference of a user according to a first embodiment of the present invention;

FIG. 2 is a block diagram illustrating a key route analysis unit shown in FIG. 1;

FIG. 3 illustrates an example of key routes extracted by a key route extraction subunit shown in FIG. 2;

FIG. 4 illustrates an example of calculation of costs of key routes by a key route cost calculation subunit;

FIG. 5 is a block diagram illustrating a user preference extraction unit shown in FIG. 1;

FIG. 6 illustrates an example of extraction of feature routes by a feature route extraction subunit;

FIG. 7 illustrates an example of extraction of route choice preference of a certain user by a user preference calculation subunit;

FIG. 8 is a block diagram illustrating a system for extracting route choice preference of a user according to a second embodiment of the present invention;

FIG. 9 is a block diagram illustrating a user preference extraction unit according to a third embodiment of the present invention;

FIG. 10 illustrates an example of division into geographical regions by a third route classification subunit; and

FIG. 11 is a flow chart illustrating a method for extracting route choice preference of a user according to the present invention.

### DETAILED DESCRIPTION OF PREFERRED EMBODIMENTS

In the following, specific embodiments according to the present invention will be described in conjunction with the accompanying drawings, so that the principles and implementations of the present invention will be more apparent. It should be noted that the present invention is not limited to the specific embodiments described below. In addition, detailed descriptions of well-known techniques unrelated to the present invention are omitted for the sake of simplicity.

### First Embodiment

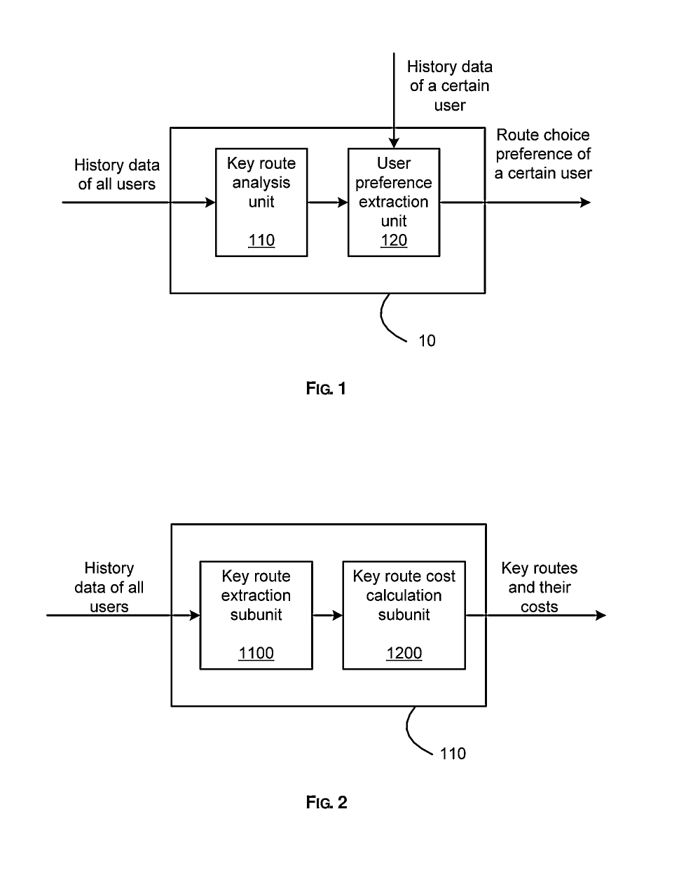

FIG. 1 is a block diagram illustrating a system 10 for extracting route choice preference of a user according to the first embodiment of the present invention. As shown in FIG. 1, the system 10 comprises a key route analysis unit 110 and a user preference extraction unit 120.

The key route analysis unit 110 receives history data of all users as input, and analyzes key routes based upon the input history data. In this embodiment, the key route analysis unit 110 analyzes history routes of all users to obtain key routes and their costs. Among the history routes of all users, a route satisfying both of the following conditions is defined as a key route: (1) the frequency of occurrence of the route is larger than a threshold; and (2) there must exist at least one other key route having the same original node and destination node as the route. In the following, the structures and operations of the key route analysis unit 110 shown in FIG. 1 will be described in detail in conjunction with FIG. 2.

FIG. 2 is a block diagram illustrating the key route analysis unit 110 shown in FIG. 1. As shown in FIG. 2, the key route analysis unit 110 comprises a key route extraction subunit 1100 and a key route cost calculation subunit 1200.

The key route extraction subunit 1100 selects pairs of key nodes by calculating a number of history routes of all users between any pair of nodes, and extracts key routes based upon the selected pairs of key nodes. Specifically, in this embodiment, the key route extraction subunit 1100 calculates a frequency of occurrence for each of the history routes of all users. Here, the frequency of occurrence of a route refers to a number of occurrences of the route in history data. Based thereon, the key route extraction subunit 1100 constructs an N*N node matrix, wherein N is a number of total nodes on routes contained in the history data. For example, the node may be a crosspoint of routes on a map, a certain building on the map, or the like.

The key route extraction subunit 1100 calculates values of all elements of the N*N node matrix. The value is used to record a number of routes passing through any two nodes. For example, supposing that the N*N node matrix is MA, then the value of MA[I, J] is the number of routes from node I to node J, with the same route being counted only once. Next, the key route extraction subunit 1100 selects pairs of key nodes based upon the calculated N*N node matrix. In the application, if MA[I, J]>=2 (i.e., there exist two or more different routes from node I to node J), I and J are referred to as a pair of key nodes, denoted as (I, J).

The key route extraction subunit 1100 extracts key routes based upon frequencies of routes between the selected pairs of key nodes. The frequency of a key route must satisfy a frequency threshold fthd. Suppose that, for the pair of nodes (I, J), routes R1(I, J), R2(I, J) and R3(I, J) exist, for example. If all the frequencies of occurrence of these routes R1-R3 are larger than the prescribed frequency threshold fthd (i.e., if Freq(R1(I, J))>=fthd, Freq(R2(I, J))>=fthd, Freq(R3(I, J))>=fthd, wherein the Freq(Ri(I, J)) denotes the frequency of occurrence of the route Ri(I, J)), then all theses routes R1(I, J), R2(I, J) and R3(I, J) are key routes. Otherwise, if Freq(R1(I, J))>=fthd and Freq(R2(I, J))>=fthd while Freq(R3(I, J))<fthd, then only routes R2(I, J) and R3(I, J) are key routes. If the frequency of occurrence of only one route is larger than the threshold fthd (e.g., if Freq(R1(I, J))>=fthd, Freq(R2(I, J))<fthd, Freq(R3(I, J))<fthd), no key route exists because the above condition (2) for defining a key route is not satisfied.

FIG. 3 illustrates an example of key routes extracted by the key route extraction subunit 1100. As shown in FIG. 3, suppose that four history routes R1, R2, R3 and R4 exist in the history data. Among these routes, R1 sequentially passes through nodes A, B, C, D and E, R2 sequentially passes through three nodes A, F and C, R3 sequentially passes through nodes H, A, B, C and I, and R4 sequentially passes through nodes A, F, C and G.

The key route extraction subunit 1100 calculates the frequencies of occurrence of R1, R2, R3 and R4 in the history data and obtains 10, 8, 7 and 12 respectively. A 9*9 node matrix in this example (the number of total nodes on history routes is 9) is shown in Table 1 as below:

TABLE 1
9 * 9 node matrix

| | A | B | C | D | E | F | G | H | I |
|---|---|---|---|---|---|---|---|---|---|
| A | 0 | 1 | 2 | 1 | 1 | 1 | 1 | 0 | 0 |
| B | 0 | 0 | 1 | 1 | 1 | 0 | 0 | 0 | 1 |
| C | 0 | 0 | 0 | 1 | 1 | 0 | 1 | 0 | 1 |
| D | 0 | 0 | 0 | 0 | 1 | 0 | 0 | 0 | 0 |
| E | 0 | 0 | 0 | 0 | 0 | 0 | 0 | 0 | 0 |
| F | 0 | 0 | 1 | 0 | 0 | 0 | 1 | 0 | 0 |
| G | 0 | 0 | 0 | 0 | 0 | 0 | 0 | 0 | 0 |
| H | 1 | 1 | 1 | 0 | 0 | 0 | 0 | 0 | 1 |
| I | 0 | 0 | 0 | 0 | 0 | 0 | 0 | 0 | 0 |

In the matrix, MA[A, C]=2 implies satisfaction of the condition for defining key nodes. Accordingly, the key route extraction subunit 1100 selects (A, C) as a pair of key nodes. Besides, two routes ABC and AFC exist between the pair of key nodes (A, C), and ABC is contained in routes R1 and R3. Therefore, the frequency of occurrence of ABC is the sum of the frequencies of occurrence of R1 and R3, namely, 10+7=17. Likewise, AFC is contained in routes R2 and R4, so the frequency of occurrence of AFC is 8+12=20. Supposing the frequency threshold fthd is 15, the key route extraction subunit 1100 will then extract ABC and AFC as key routes.

Referring back to FIG. 2, the key route extraction subunit 1100 provides the extracted key routes to the key route cost calculation subunit 1200. The key route cost calculation subunit 1200 classifies the key routes and calculates cost values of the key routes in the same group for each cost. In this embodiment, the key route cost calculation subunit 1200 classifies key routes having the same original node and destination node into a group, calculates cost values of the key routes in the same group for each cost, and compares the calculated cost values to assign the costs to the key routes. Specifically, a cost is assigned to a key route having an optimal value for the cost, if the cost has a numerical value. A cost is assigned to each of the key routes, if the cost has a non-numerical value.

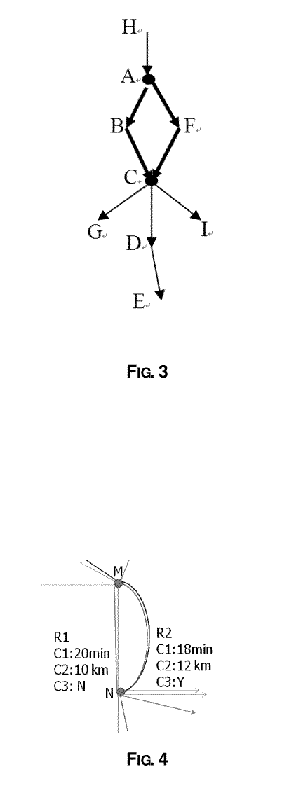

FIG. 4 illustrates an example of calculation of costs of key routes by the key route cost calculation subunit 1200. As shown in FIG. 4, it is supposed that (M, N) are a pair of key nodes and that R1(M, N) and R2(M, N) are key routes from the original node M to the destination node N. In this example, cost c1 represents travel time of a route, c2 represents a distance of a route, and c3 indicates whether a toll road is included. The key route cost calculation subunit 1200 calculates values corresponding to R1(I, J), R2(I, J) and R3(I, J), and obtains results shown in FIG. 4. That is, c1 has a value of 20 minutes for R1 and 18 minutes for R1, c2 has a value of 10 kilometres for c1 and 12 kilometres for c2, and c3 has a value of “no” (N) for R1 and “yes” (Y) for R2.

After obtaining all cost values, the key route cost calculation subunit 1200 assigns these costs to corresponding key routes. In this example, the cost c1 (travel time) has a numerical value for which the larger the better, so it is assigned to R2. The cost c2 (distance) has a numerical value for which the smaller the better, so it is assigned to R1. The cost c3 (including toll road or not) has a non-numerical value (Boolean), so it is assigned to R1 and R2. The final results of the calculation are as follows:

R1(M, N) have the costs c2 and c3(N), wherein c3(N) represents no toll road is included. This result shows that R1(M, N) is superior in terms of distance and does not include a toll road.

R2(M, N) have the costs c1 and c3(Y), wherein c3(Y) represents a toll road is included. This result shows that R2(M, N) is superior in terms of time and includes a toll road.

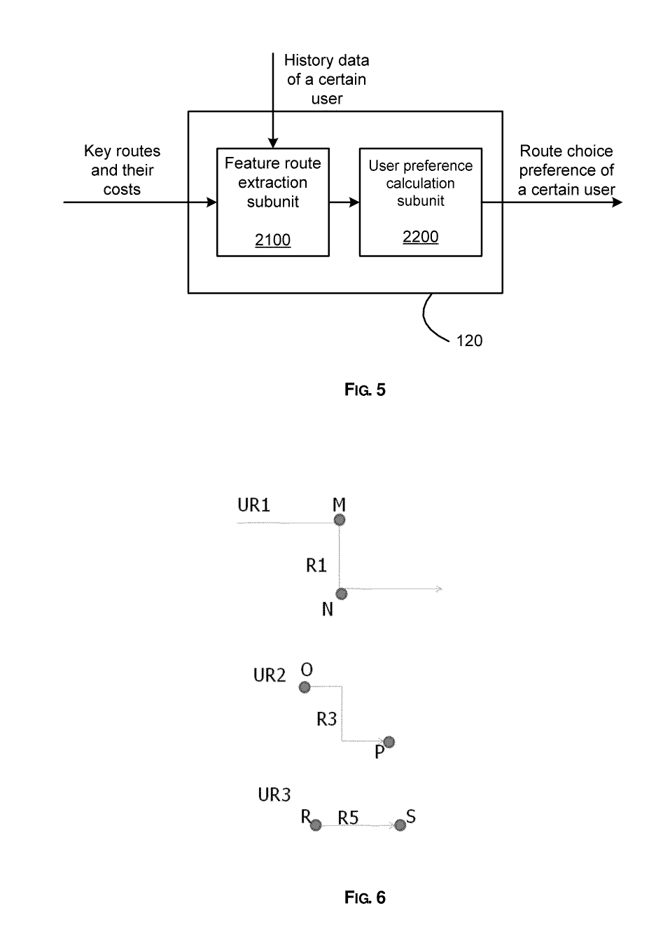

FIG. 5 is a block diagram illustrating the user preference extraction unit 120 shown in FIG. 1. As shown in FIG. 5, the user preference extraction unit 120 comprises a feature route extraction subunit 2100 and a user preference calculation subunit 2200.

The feature route extraction subunit 2100 extracts, from the history routes of a certain user, a path which is identical to a key route and has a frequency of occurrence that is larger than a threshold as a feature route of the certain user. The path may be an entire route or a part of it. The feature route of the user must satisfy both of the following conditions: (1) it is a key route; and (2) the frequency of its occurrence is larger than the threshold. In the following, the operations of the feature route extraction subunit 2100 will be described in detail in conjunction with FIG. 6.

FIG. 6 illustrates an example of extraction of feature routes by the feature route extraction subunit 2100. As shown in FIG. 6, it is supposed that the feature route extraction subunit 2100 extracts, from the history routes of user A, three history routes (UR1, UR2, UR3) including key routes, wherein URI includes the key route R1(M, N), UR2 is precisely a key route R3(O, P) and UR3 is precisely a key route R5(R, S). Subsequently, the feature route extraction subunit 2100 calculates numbers of times that the user A travels along these three routes, and obtains freq(R1(M, N))=20, freq(R3(O, P))=8 and freq(R5(R, S))=1. Supposing that a threshold uthd is 5, then R1(M, N) is a feature route of the user A because freq(R1(M, N))=20>uthd, R3(O, P) is also a feature route of the user A because freq(R3(M, N))=8>uthd, while R5(R, S) is not a feature route of the user A because freq(R5(R, S))=1<uthd. In summary, the feature route extraction subunit 2100 determines that the user A has two feature routes: R1(M, N) and R3(O, P).

Referring back to FIG. 5, the feature route extraction subunit 2100 provides the feature routes of the certain user to the user preference calculation subunit 2200. The user preference calculation subunit 2200 calculates weights for the route choice preference of the certain user based upon the costs of the feature routes of the certain user, and calculates the route choice preference of the certain user based upon the weights. In this embodiment, it is supposed that the user preference to be analyzed in the system includes c1, c2, c3, . . . , cn. The feature route extraction subunit 2100 at first initializes weights of these costs to 0, namely, w(ci)=0, i=1, 2, . . . , n. Then, accumulation is performed for each cost of feature routes of a certain user, in order to obtain the weight of user preference for the cost. That is, if there are n feature routes that have the cost ci, then w(ci)=n.

The user preference calculation subunit 2200 selects all the costs whose weights are larger than 0, and filters non-numerical cost values. The filter criterion is that, if any two non-numerical cost values describe the same cost, only the cost value having the largest weight is reserved. For example, for a weight w(including highway)=4 and a weight w(not including highway)=2, the user's preference is including highway, which suggests the user prefers to take a highway.

FIG. 7 illustrates an example of extraction of route choice preference of a certain user by the user preference calculation subunit 2200. As shown in FIG. 7, the user A has two feature routes R2(M,N) and R3(O,P). R2(M,N) has the costs c1(time) and c3(not including highway). R3(O,P) has the costs c1(time) and c2(distance). The costs of these two feature routes are added to obtain a result of user preference including c1(time), c2(distance) and c3(not including highway) whose weights are w(c1)=2, w(c2)=1 and w(c3)=1 respectively. Therefore, the route choice preference of the user A extracted by the user preference calculation subunit 2200 is that: the user A is most concerned about the travel time (c1), next the distance (c2), and does not like to take a highway (c3).

With the system for extracting route choice preference of a user according to this embodiment of the present invention, the route choice preference of the user can be automatically extracted from history data without requiring the user to preset his/her own preference. In this embodiment, neither the number of costs about which each user is concerned nor the weight of each cost is fixed but is calculated based upon each user's history data, which is more suitable for the practical situation when the user makes route choice. Moreover, as compared with existing systems which adopt fixed levels of weights, the system according to this embodiment can determine the priority for each cost more accurately.

### Second Embodiment

In practical applications, user preference may vary in different conditions (for example, in different time periods), and therefore these conditions need to be taken into account in extraction of route choice preference of a user. In this embodiment, corresponding key routes are extracted for different time periods and then feature routes of a user in the time periods are extracted, in order to obtain user choice preferences in different time periods.

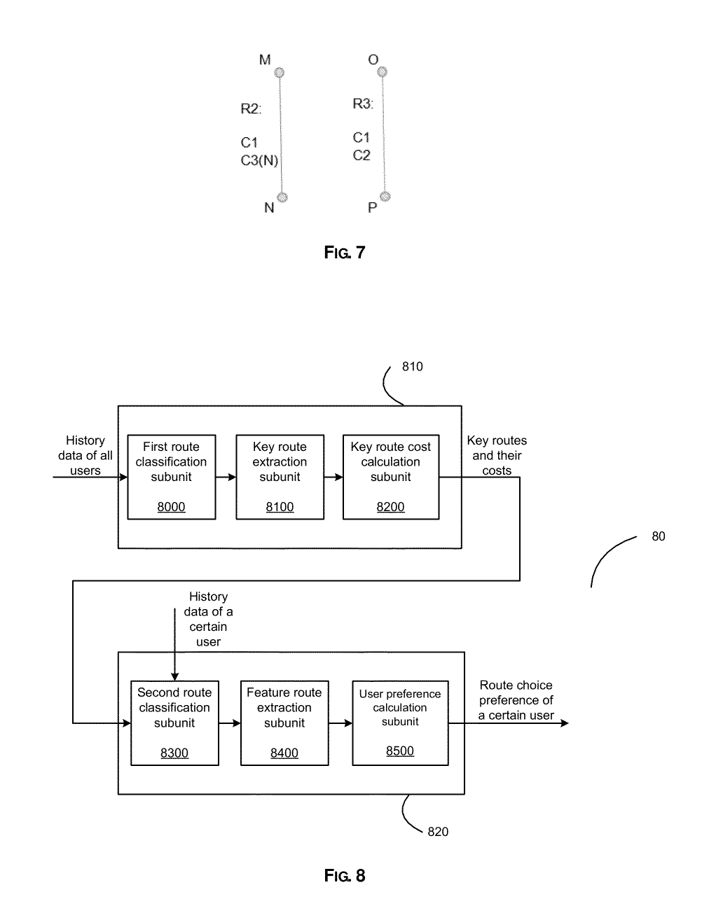

FIG. 8 is a block diagram illustrating a system 80 for extracting route choice preference of a user according to the second embodiment of the present invention. The system 80 comprises a key route analysis unit 810 and a user preference extraction unit 820. The key route analysis unit 810 comprises a first route classification subunit 8000, a key route extraction subunit 8100 and a key route cost calculation subunit 8200, and the user preference extraction unit 820 comprises a second route classification subunit 8300, a feature route extraction subunit 8400 and a user preference calculation subunit 8500. The key route extraction subunit 8100 and the key route cost calculation subunit 8200 in this embodiment are respectively the same as the key route extraction subunit 1100 and key route cost calculation subunit 1200 shown in FIG. 2, and the feature route extraction subunit 8400 and the user preference calculation subunit 8500 are respectively the same as the feature route extraction subunit 2100 and the user preference calculation subunit 2200 shown in FIG. 5. For the sake of simplicity, only the first route classification subunit 8000 and second route classification subunit 8300 will be described in detail in the following.

The first route classification subunit 8000 classifies history routes of all users in accordance with a certain criterion, and provides the classified history routes to the key route extraction subunit 8100. Likewise, the second route classification subunit 8300 classifies history routes of a certain user in accordance with a certain criterion, and provides the classified routes to the feature route extraction subunit 8400.

The certain criterion may comprise any of the following: time periods in a day, date type, or weather condition. For example, the certain criterion may be the time periods in a day. In this case, the time period from 7:00 AM to 9:00 AM may be classified as morning peak hours, the time period from 17:00 PM to 19:00 PM may be classified as evening peak hours, and the time period from 9:00 AM to 17:00 PM may be classified as non-peak hours, etc. In addition, the certain criterion may be the date type (such as workday, weekend, legal holiday, etc.). The certain criterion may also be the weather condition (e.g., clear, rainy, snowy, etc.). Those skilled in the art would appreciate that the certain criterion is not limited to those described above, and other classification criteria may be used according to practical application scenarios.

With the system according to this embodiment, the route preference choice of a user can be adjusted in accordance with different criteria, and thus the user preference can be calculated more accurately.

### Third Embodiment

In practical applications, user preference may vary with travel regions. Typically, a user has different route choice preferences in a region which he/she is familiar with and a region which he/she is not familiar with. Therefore, in some cases, this region factor needs to be taken into account in extraction of user preference. In this embodiment, active regions and non-active regions are initially extracted based on a user's history data, wherein the active regions are regions in which the user often travels (i.e., regions which the user is familiar with) and the non-active regions are regions in which the user does not often travel (i.e., regions which the user is not familiar with). Subsequently, corresponding feature routes are extracted respectively for the active regions and the non-active regions, and then route choice preferences of the user in different regions are obtained.

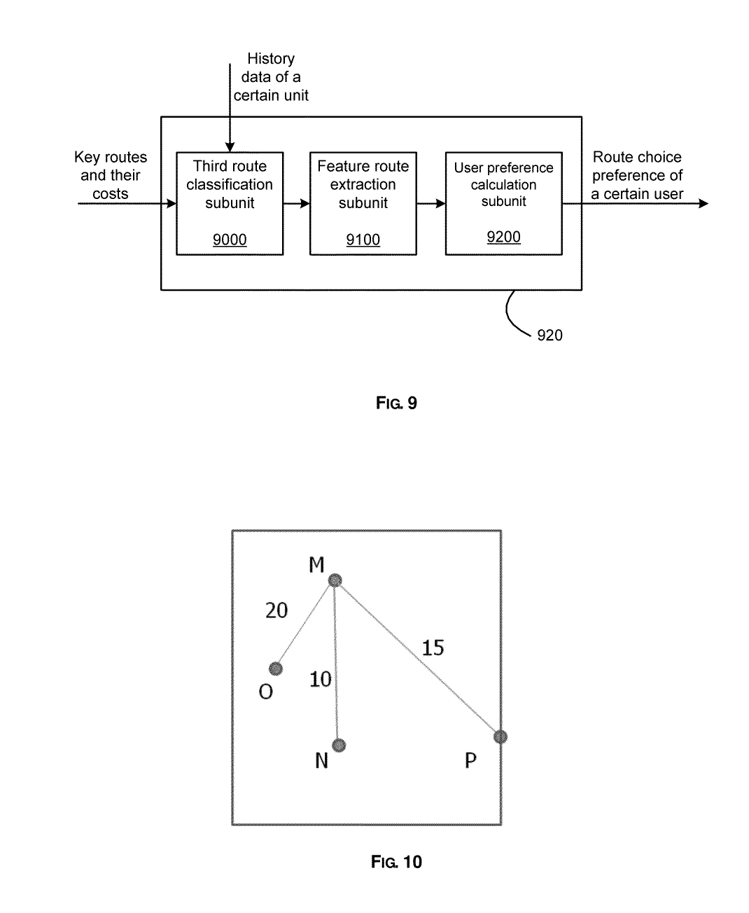

FIG. 9 is a block diagram illustrating a user preference extraction unit 920 according to the third embodiment of the present invention. As shown in FIG. 9, the user preference extraction unit 920 comprises a third route classification subunit 9000, a feature route extraction subunit 9100 and a user preference calculation subunit 9200. The feature route extraction subunit 9100 and the user preference calculation subunit 9200 are respectively the same as the feature route extraction subunit 2100 and the user preference calculation subunit 2200 shown in FIG. 5. For the sake of simplicity, only the third route classification subunit 9000 will be described in detail in the following.

The third route classification subunit 9000 classifies the history routes of a certain user in accordance with geographical regions, and provides the classified certain routes to the feature route extraction subunit 9100. Specifically, the third route classification subunit 9000 may divide a map into a plurality of regions, classify the plurality of regions as active regions and non-active regions in accordance with activity and cognition of a certain user in the regions, and then classify the history routes of the certain user as active region routes and non-active region routes.

The criterion on which the division of a map into regions is based may be fixed size, regionalism, urban function (such as working function, living function, commercial function, etc.) or the like. Those skilled in the art would appreciate that the division criterion is not limited to those described above and other division criteria may be used as needed.

For a region, the third route classification subunit 9000 extracts history routes of a certain user in the region, and calculates the activity of the user in the region. In this embodiment, for a region unitᵢ, the activity of the user in the region is defined as ActDgr(unitᵢ), wherein ActDgr(unitᵢ) is a number of total travel times of the user in the region unitᵢ, namely, a sum of frequencies of occurrence of all the routes. Higher activity indicates that the user travels more times in the region. In addition, the third route classification subunit 9000 calculates the cognition of the user in the region. For the region unitᵢ, the cognition of the user in the region is defined as CogDgr(unitᵢ), wherein CogDgr(unitᵢ) is a number of routes in unit, along which the user has travelled, namely, a number of all the routes. Higher cognition indicates that the user travels a wider scope within the region. In an example, if the activity and cognition of the user in the region unit, are respectively larger than prescribed thresholds athd and cthd, then the third route classification subunit 9000 classifies the region unit, as an active region; otherwise, the third route classification subunit 9000 classifies the region unit, as a non-active region.

For a history route of a user, if the length the route runs in active regions is greater than or equal to the length the route runs in non-active regions, the third route classification subunit 9000 classifies the route as an active region route; otherwise, the third route classification subunit 9000 classifies the route as a non-active region route.

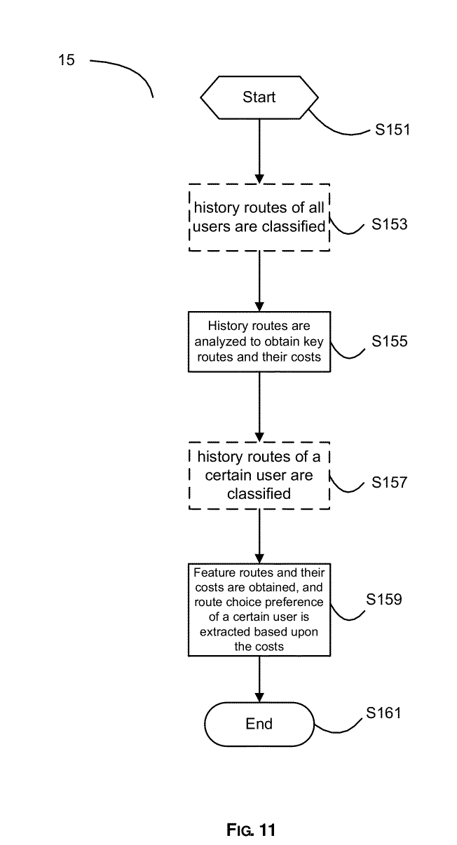

FIG. 10 illustrates an example of division into geographical regions by the third route classification subunit 9000. In FIG. 10, there is illustrated a divided region, which includes three routes (paths) of the user A (namely, MO, MN and MP) having corresponding frequencies of occurrence 20, 10 and 15. Thereby, the third route classification subunit 9000 calculates the activity and cognition of the user A in the region and obtains ActDgr=20+10+15=45 and CogDgr=3. Supposing athd=40 and cthd=4, the third route classification subunit 9000 classifies the region as a non-active region of the user A because ActDgr>athd and CogDgr<cthd.

With the system according to this embodiment, corresponding route preferences can be selected based upon the user's familiarity with different regions, and thus personalized route choice can be provided.

FIG. 11 is a flow chart illustrating a method 15 for extracting route choice preference of a user according to the present invention. The method 15 may be performed by the systems according to the above embodiments of the present invention.

Referring to FIG. 11, the method 15 begins with step S151. At step S155, history routes of all users are analyzed to obtain key routes and their costs. Preferably, the step S155 may comprise: selecting pairs of key nodes by calculating a number of history routes of all users between any pair of nodes, and extracting the key routes based upon the selected pairs of key nodes; and grouping the key routes and calculating cost values of the key routes in the same group for each cost.

According to an embodiment of the present invention, two nodes which have two or more routes connected therebetween are selected as a pair of key nodes. Routes represented by a pair of key nodes and two or more of which having a frequency of occurrence that is larger than a threshold are selected as key routes.

In addition, according to an embodiment of the present invention, key routes having the same original node and destination node may be put into a group, cost values of the key routes in the same group may be calculated for each cost, and the calculated cost values may be compared to assign the costs to the key routes. Specifically, a cost is assigned to a key route having an optimal value for the cost if the cost has a numerical value, and a cost is assigned to each of the key routes if the cost has a non-numerical value.

Next, the method proceeds to step S159. At the step S159, feature routes of a certain user and their costs are obtained based upon the key routes and their costs as well as history routes of the certain user, and route choice preference of the certain user is extracted based upon the feature routes of the certain user and their costs.

According to an embodiment of the present invention, the feature routes of the certain user from the key routes may be extracted based upon the history routes of the certain user, and weights for the route choice preference of the certain user may be calculated based upon the costs of the feature routes of the certain user and the route choice preference of the certain user may be calculated based upon the weights.

According to an embodiment of the present invention, a path which is identical to a key route and has a frequency of occurrence that is larger than a threshold may be extracted from the history routes of the certain user as a feature route of the certain user.

Besides the above steps, additional steps may be added. For example, the history routes of all users may be classified in accordance with a certain criterion at step S153 before the step S155, and the history routes of the certain user may be classified in accordance with the certain criterion at step S157 before the step S159. Preferably, the certain criterion may comprise any of the following: time periods in a day, date type, or weather condition.

Alternatively, the additional step S157 may be added between the step S155 and the step S159. At the step S157, the history routes of the certain user may be classified in accordance with geographical regions. According to an embodiment of the present invention, the regions may be classified as active regions and non-active regions in accordance with a number of the history routes of the certain user and a number of total travel times for the history routes of the certain user.

Finally, the method 15 ends at step S161.

It should be understood that the above embodiments of the present invention may be implemented in software, hardware or a combination thereof. For example, the key route analysis units 110 and 810, the user preference extraction units 120 and 820 as well as various components inside the units may be implemented by a variety of devices, which include but are not limited to Digital Signal Processing (DSP) circuits, programmable processors, Application Specific Integrated Circuits (ASICs), Field Programmable Gate Arrays (FPGAs), Complex Programmable Logic Devices (CPLDs), etc.

The history data of all users described in the embodiments of the present invention may be stored in a database, so as to be easily acquired by the key route analysis unit. In addition, the key routes obtained by the key route analysis unit through analysis may also be stored in the database for acquisition by the user preference extraction unit. Further, the user preference extracted by the user preference unit may also be stored in the database in order to facilitate maintenance and later reuse. Those skilled in the art would appreciate that the above data may be stored in one and the same database or in multiple different databases (such as distributed databases).

In addition, the embodiments of the present invention disclosed herein may be implemented on a computer program product. Specifically, the computer program product may be a product including a computer-readable medium having computer program logic coded thereon, which, when executed on a computing device, provides related operations to achieve the above technical solutions of the present invention. When executed on at least one processor of a computing system, the computer program logic causes the processor to perform the operations (method) as set forth in the embodiments of the present invention. This arrangement of the present invention is typically provided as software, code and/or other data structures set or coded on a computer-readable medium, such as an optical medium (e.g., a CD-ROM), a floppy disk, a hard disk, or the like, or other media such as firmware or microcode on one or more ROM, RAM or PROM chips, or one or more downloadable software images in one or more modules, shared databases, etc. Software, firmware or this arrangement may be installed on a computing device, causing one or more processors of the computer device to implement the technical solutions as set forth in the embodiments of the present invention.

While the present invention has been described with respect to preferred embodiments thereof, those skilled in the art would appreciate that various changes, substitutions, and alternations can be made without departing from the spirit and scope of the present invention. Therefore, the present invention is not limited to the above exemplary embodiments, but is defined by the appended claims and their equivalents.

What is claimed is:

1. A system for extracting route choice preference of a user, the system comprising:
a key route analysis unit configured to analyze history routes of all users to obtain key routes and their costs; and
a user preference extraction unit configured to obtain feature routes of a user and their costs based upon the key routes and their costs as well as history routes of a user, and to extract route choice preference of the user based upon the feature routes of the user and their costs.

2. The system according to claim 1, wherein the key route analysis unit comprises:
a key route extraction subunit configured to select pairs of key nodes by calculating a number of history routes of all users between any pair of nodes, and to extract the key routes based upon the selected pairs of key nodes; and
a key route cost calculation subunit configured to group the key routes and to calculate cost values of the key routes in the same group for each cost.

3. The system according to claim 2, wherein the key route extraction subunit is configured to select two nodes which have two or more routes connected therebetween as a pair of key nodes, and to select routes represented by a pair of key nodes and two or more of which having a frequency of occurrence that is larger than a first threshold as key routes.

4. The system according to claim 2, wherein the key route cost calculation subunit is configured to put key routes having the same original node and destination node into a group, to calculate cost values of the key routes in the same group for each cost, and to compare the calculated cost values to assign the costs to the key routes.

5. The system according to claim 4, wherein the key route cost calculation subunit is configured to assign a cost to a key route having an optimal value for the cost if the cost has a numerical value, and to assign a cost to each of the key routes if the cost has a non-numerical value.

6. The system according to claim 2, wherein
the key route analysis unit further comprises a first route classification subunit configured to classify the history routes of all users in accordance with a certain criterion, and to provide the classified history routes to the key route extraction subunit;
the user preference extraction unit further comprises a second route classification subunit configured to classify the history routes of the user in accordance with the certain criterion, and to provide the classified history routes to the feature route extraction subunit.

7. The system according to claim 6, wherein the certain criterion comprises any of time periods in a day, date type, and weather condition.

8. The system according to claim 1, wherein the user preference extraction unit comprises:
a feature route extraction subunit configured to extract the feature routes of the user from the key routes based upon the history routes of the user; and
a user preference calculation subunit configured to calculate weights for the route choice preference of the user based upon the costs of the feature routes of the user, and to calculate the route choice preference of the user based upon the weights.

9. The system according to claim 8, wherein the feature route extraction subunit is configured to extract, from the history routes of the user, a path which is identical to a key route and has a frequency of occurrence that is larger than a second threshold as a feature route of the user.

10. The system according to claim 8, wherein the user preference extraction unit further comprises:
a third route classification subunit configured to classify the history routes of the user in accordance with geographical regions, and to provide the classified history routes to the feature route extraction subunit.

11. The system according to claim 10, wherein the third route classification subunit is configured to divide a map into a plurality of regions, and to classify the plurality of regions as active regions and non-active regions in accordance with a number of the history routes of the user and a number of total travel times for the history routes of the user.

12. A method for extracting route choice preference of a user, the method comprising:
analyzing history routes of all users to obtain key routes and their costs; and
obtaining feature routes of a user and their costs based upon the key routes and their costs as well as history routes of the user, and extracting route choice preference of the user based upon the feature routes of the user and their costs.

13. The method according to claim 12, wherein the step of analyzing comprises:
selecting pairs of key nodes by calculating a number of history routes of all users between any pair of nodes, and extracting the key routes based upon the selected pairs of key nodes; and
grouping the key routes and calculating cost values of the key routes in the same group for each cost.

14. The method according to claim 13, wherein the steps of selecting and extracting comprise:
selecting two nodes which have two or more routes connected therebetween as a pair of key nodes, and routes represented by a pair of key nodes and two or more of which having a frequency of occurrence that is larger than a first threshold as key routes.

15. The method according to claim 13, wherein the steps of grouping and calculating comprise:
putting key routes having the same original node and destination node into a group, calculating cost values of the key routes in the same group for each cost, and comparing the calculated cost values to assign the costs to the key routes.

16. The method according to claim 15, wherein the step of comparing comprises:
assigning a cost to a key route having an optimal value for the cost if the cost has a numerical value, and a cost to each of the key routes if the cost has a non-numerical value.

17. The method according to claim 13, further comprising:
classifying the history routes of all users in accordance with a certain criterion before the step of extracting the key routes; and
classifying the history routes of the user in accordance with the certain criterion before the step of extracting the feature routes.

18. The method according to claim 17, wherein the certain criterion comprises any of time periods in a day, date type, and weather condition.

19. The method according to claim 12, wherein the step of obtaining and extracting comprises:
extracting the feature routes of the user from the key routes based upon the history routes of the user; and
calculating weights for the route choice preference of the user based upon the costs of the feature routes of the user, and the route choice preference of the user based upon the weights.

20. The method according to claim 19, wherein the step of extracting comprises:
extracting, from the history routes of the user, a path which is identical to a key route and has a frequency of occurrence that is larger than a second threshold as a feature route of the user.

21. The method according to claim 19, further comprising:
classifying the history routes of the user in accordance with geographical regions before the step of extracting the feature routes.

22. The method according to claim 21, wherein the step of classifying comprises:
dividing a map into a plurality of regions, and classifying the plurality of regions as active regions and non-active regions in accordance with a number of the history routes of the user and a number of total travel times for the history routes of the user.
